(19) United States
(12) Patent Application Publication
(10) Pub. No.: US 2026/0073634 A1
(43) Pub. Date: Mar. 12, 2026

(54) METHOD AND APPARATUS FOR PLANE SEGMENTATION OF THREE-DIMENSIONAL RENDERING GRADIENT MULTI-LEVEL PLANE

(71) Applicant: TOPDON TECHNOLOGY Co., Ltd., Shenzhen (CN)

(72) Inventors: Zhenbin Zhou, Shenzhen (CN); Ke Lou, Shenzhen (CN); Jianfeng Li, Shenzhen (CN); Chaolin Bin, Shenzhen (CN); Wenli Qin, Shenzhen (CN)

(21) Appl. No.: 19/052,258

(22) Filed: Feb. 12, 2025

(30) Foreign Application Priority Data
Sep. 12, 2024 (CN) 202411280530.6

(51) Int. Cl. G06T 17/20; H04N 13/275

(52) U.S. Cl. CPC G06T 17/20; H04N 13/275; G06T 2210/21

(57) ABSTRACT

Disclosed is a method and an apparatus for plane segmentation of a three-dimensional rendering gradient multi-level plane. The method includes: performing a grayscale conversion on a target image, and performing a projection and pixel grouping on a first image processing result obtained by the grayscale conversion, so as to obtain a second image processing result including a plurality of triangular patches; performing determination of vertexes for each triangular patch, determination of intersections between a plane where each triangular patch is located and a predetermined section, and connection of the intersections on the second image processing result, so as to obtain a third image processing result; and performing segmentation processing, classification processing, and gradient color rendering on non-triangular parts in the third image processing result in accordance with the pixel grouping condition, so as to obtain a fourth image processing result including a target rendered image.

### CROSS-REFERENCE TO RELATED APPLICATIONS

The present disclosure claims the priority of Chinese Patent Application No. 2024112805306 filed on Sep. 12, 2024 before CNIPA. all of the above are hereby incorporated by reference in their entirety.

### TECHNICAL FIELD

The present disclosure relates to the technical field of image processing, and in particular, to a method and an apparatus for plane segmentation of a three-dimensional rendering gradient multi-level plane.

### BACKGROUND

With the rapid development of computer graphics, three-dimensional image rendering technology has become an indispensable core technology in many fields such as visual arts, game design, film and television production, and architectural design. However, existing three-dimensional image rendering techniques still face many challenges and deficiencies in practical applications. Among them, the current three-dimensional real-time rendering technology relies on complex algorithms and huge amounts of data, leading to the high difficulty of the algorithms involved and the enormous amount of computation. For a large-scale or high-resolution three-dimensional scene, a rendering time may be relatively long, which limits the application scenarios for real-time rendering technology. Evidently, it is particularly important to propose a corresponding solution to the technical problems of high complexity of rendering algorithms, large amount of computation, and low rendering efficiency that exist in the existing three-dimensional rendering techniques.

### SUMMARY

Provided in the present disclosure are a method and an apparatus for plane segmentation of a three-dimensional rendering gradient multi-level plane, which are capable of being beneficial for reducing the amount of computational data for three-dimensional rendering, realizing algorithmic optimization of three-dimensional rendering technology, and improving the computational efficiency of three-dimensional rendering.

In order to solve the above technical problem, in a first aspect of the present disclosure, disclosed is a method for plane segmentation of a three-dimensional rendering gradient multi-level plane, including:
performing predetermined first image processing on an acquired target image, so as to obtain a first image processing result corresponding to the target image, the first image processing at least including a grayscale conversion;
performing, in accordance with a predetermined pixel grouping condition, second image processing on the first image processing result, so as to obtain a second image processing result corresponding to the first image processing result, the second image processing including three-dimensional projection and pixel grouping, and the second image processing result including a plurality of triangular patches;
performing third image processing on each of the plurality of triangular patches in the second image processing result, so as to obtain a third image processing result corresponding to all of the plurality of triangular patches, the third image processing including determination of vertexes for each of the plurality of triangular patches, determination of intersections between a plane where each of the plurality of triangular patches is located and a predetermined section, and connection of the intersections; and
performing, in accordance with the pixel grouping condition, fourth image processing on non-triangular parts in the third image processing result, so as to obtain a fourth image processing result corresponding to the third image processing result, in which the fourth image processing includes segmentation processing, classification processing, and gradient color rendering, and the fourth image processing result includes a target rendered image corresponding to the target image.

As an optional implementation, in the first aspect of the present disclosure, the performing, in accordance with a predetermined pixel grouping condition, the second image processing on the first image processing result, so as to obtain the second image processing result corresponding to the first image processing result includes:
constructing a stereo model, and then establishing a three-dimensional coordinate system matched with the stereo model, in which the first image processing result includes a grayscale image corresponding to the target image, the three-dimensional coordinate system takes a length of the grayscale image as a first axis, a width of the grayscale image as a second axis, and a grayscale value of the grayscale image as a third axis, the first axis and the second axis are in a same foundation plane, and the third axis is perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result including a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, in which each of the plurality of quadrangles consists of four of the plurality of three-dimensional pixels and all of the plurality of quadrangles do not overlap each other;
calculating, for each of the plurality of quadrangles, a diagonal distance corresponding to any two diagonal pixels in the respective quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangles at diagonal positions; and
determining the diagonal connection results corresponding to all of the plurality of quadrangles as the second image processing result corresponding to the first image processing result.

As an optional implementation, in the first aspect of the present disclosure, the selecting, in accordance with the predetermined pixel grouping requirement, the target diagonal distance from the two diagonal distances corresponding to the quadrangle includes:
determining, in accordance with a corresponding grayscale value of each of the diagonal pixels, a pixel attribute of each of the diagonal pixels, in which the pixel attribute includes a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with the same pixel attributes as a first pixel pair, and identifying two of the diagonal pixels of the quadrangle with different pixel attributes as a second pixel pair, the quadrangle including a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance.
the quadrangle satisfies the first grouping condition specifically in that the quadrangle has both the first pixel pair and the second pixel pair, and the second grouping condition is opposite to the first grouping condition.
the performing the third image processing on each of the plurality of triangular patches in the second image processing result, so as to obtain the third image processing result corresponding to all of the plurality of triangular patches includes:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

As an optional implementation, in the first aspect of the present disclosure, the performing, in accordance with the pixel grouping condition, a fourth image processing on non-triangular parts in the third image processing result, so as to obtain a fourth image processing result corresponding to the third image processing result includes:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

As an optional implementation, in the first aspect of the present disclosure, the performing, in accordance with the predetermined rendering mode, the gradient color rendering on each of the target closed surfaces, so as to obtain the gradient color rendering result corresponding to each of the target closed surfaces includes:
obtaining a two-dimensional surface projection corresponding to each of the target closed surfaces in the foundation plane, the two-dimensional surface projection including a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.

As an optional implementation, in the first aspect of the present disclosure, the calculating, for each of the plurality of quadrangles, the diagonal distance corresponding to any two diagonal pixels in the respective quadrangle includes:
identifying, for each of the plurality of quadrangles, a three-dimensional coordinate corresponding to each of the three-dimensional pixels in the quadrangle, and, at the same time, identifying two of the three-dimensional pixels in the quadrangle at diagonal positions as a diagonal pixel pair, the diagonal pixel pair including two diagonal pixels; and
calculating, for each of the diagonal pixel pairs in each of the plurality of quadrangles, a distance between the two diagonal pixels in the diagonal pixel pair in accordance with a predetermined two-point distance formula, so as to obtain the diagonal distance corresponding to the two diagonal pixels in the diagonal pixel pair.

In a second aspect of the present disclosure, disclosed is an apparatus for plane segmentation of a three-dimensional rendering gradient multi-level plane, including:
a first image processing module, configured to perform predetermined first image processing on an acquired target image, so as to obtain a first image processing result corresponding to the target image, the first image processing at least including a grayscale conversion;
a second image processing module, configured to perform second image processing on the first image processing result in accordance with a predetermined pixel grouping condition, so as to obtain a second image processing result corresponding to the first image processing result, the second image processing including three-dimensional projection and pixel grouping, and the second image processing result including a plurality of triangular patches;
a third image processing module, configured to perform third image processing on each of the plurality of triangular patches in the second image processing result, so as to obtain a third image processing result corresponding to all of the plurality of triangular patches, the third image processing including determination of vertexes for each of the plurality of triangular patches, determination of intersections between a plane where each of the plurality of triangular patches is located and a predetermined section, and connection of the intersections; and
a fourth image processing module, configured to perform fourth image processing on non-triangular parts in the third image processing result in accordance with the pixel grouping condition, so as to obtain a fourth image processing result corresponding to the third image processing result, in which the fourth image processing includes segmentation processing, classification processing, and gradient color rendering, and the fourth image processing result includes a target rendered image corresponding to the target image.

As an optional implementation, in the second aspect of the present disclosure, the second image processing module performing second image processing on the first image processing result in accordance with a predetermined pixel grouping condition, so as to obtain a second image processing result corresponding to the first image processing result specifically includes:
constructing a stereo model, and then establishing a three-dimensional coordinate system matched with the stereo model, in which the first image processing result includes a grayscale image corresponding to the target image, the three-dimensional coordinate system takes a length of the grayscale image as a first axis, a width of the grayscale image as a second axis, and a grayscale value of the grayscale image as a third axis, the first axis and the second axis are in a same foundation plane, and the third axis is perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result including a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, in which each of the plurality of quadrangles consists of four of the plurality of three-dimensional pixels and all of the plurality of quadrangles do not overlap each other;
calculating, for each of the plurality of quadrangles, a diagonal distance corresponding to any two diagonal pixels in the quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangles at diagonal positions; and
determining the diagonal connection results corresponding to all of the plurality of quadrangles as the second image processing result corresponding to the first image processing result.

As an optional implementation, in the second aspect of the present disclosure, the second image processing module selecting a target diagonal distance from the two diagonal distances corresponding to the quadrangle in accordance with a predetermined pixel grouping requirement specifically includes the following steps:
determining, in accordance with a corresponding grayscale value of each of the diagonal pixels, a pixel attribute of each of the diagonal pixels, in which the pixel attribute includes a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with the same pixel attributes as a first pixel pair, and identifying two of the diagonal pixels of the quadrangle with different pixel attributes as a second pixel pair, the quadrangle including a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance.
the quadrangle satisfies the first grouping condition specifically in that the quadrangle has both the first pixel pair and the second pixel pair, and the second grouping condition is opposite to the first grouping condition.

As an optional implementation, in the second aspect of the present disclosure, the second image processing module performing the third image processing on each of the plurality of triangular patches in the second image processing result, so as to obtain the third image processing result corresponding to all of the plurality of triangular patches specifically includes the following steps:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

As an optional implementation, in the second aspect of the present disclosure, the fourth image processing module performing a fourth image processing on non-triangular parts in the third image processing result, in accordance with the pixel grouping condition, so as to obtain a fourth image processing result corresponding to the third image processing result specifically includes the following steps:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

As an optional implementation, in the second aspect of the present disclosure, the fourth image processing module performing, in accordance with the predetermined rendering mode, the gradient color rendering on each of the target closed surfaces, so as to obtain the gradient color rendering result corresponding to each of the target closed surfaces specifically includes the following steps:
obtaining a two-dimensional surface projection corresponding to each of the target closed surfaces in the foundation plane, the two-dimensional surface projection including a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.

As an optional implementation, in the second aspect of the present disclosure, the second image processing module calculating, for each of the plurality of quadrangles, the diagonal distance corresponding to any two diagonal pixels in the quadrangle specifically includes the following steps:
identifying, for each of the plurality of quadrangles, a three-dimensional coordinate corresponding to each of the three-dimensional pixels in the quadrangle, and, at the same time, identifying two of the three-dimensional pixels in the quadrangle at diagonal positions as a diagonal pixel pair, the diagonal pixel pair including two diagonal pixels; and
calculating, for each of the diagonal pixel pairs in each of the plurality of quadrangles, a distance between the two diagonal pixels in the diagonal pixel pair in accordance with a predetermined two-point distance formula, so as to obtain the diagonal distance corresponding to the two diagonal pixels in the diagonal pixel pair.

In a third aspect of the present disclosure, disclosed is another apparatus for plane segmentation of a three-dimensional rendering gradient multi-level plane, including:
a memory, memorized with an executable code; and
a processor, coupled with the memory.

The processor invokes the executable code memorized in the memory to perform the method for plane segmentation of the three-dimensional rendering gradient multi-level plane disclosed according to a first aspect of the present disclosure.

In a fourth aspect of the present disclosure, disclosed is a non-transitory computer memory medium. The non-transitory computer memory medium memorizes computer instructions. When invoked, the computer instructions are configured to cause the method for plane segmentation of the three-dimensional rendering gradient multi-level plane disclosed in the first aspect of the present disclosure to be performed.

Compared to the prior art, the embodiments of the present disclosure have beneficial effects as follows:

In the embodiment of the present disclosure, provided is a method for plane segmentation of a three-dimensional rendering gradient multi-level plane, including: performing predetermined first image processing on an acquired target image, so as to obtain a first image processing result corresponding to the target image, the first image processing at least including a grayscale conversion; performing, in accordance with a predetermined pixel grouping condition, second image processing on the first image processing result, so as to obtain a second image processing result corresponding to the first image processing result, the second image processing including three-dimensional projection and pixel grouping, and the second image processing result including a plurality of triangular patches; performing third image processing on each of the plurality of triangular patches in the second image processing result, so as to obtain a third image processing result corresponding to all of the plurality of triangular patches, the third image processing including determination of vertexes for each of the plurality of triangular patches, determination of intersections between a plane where each of the plurality of triangular patches is located and a predetermined section, and connection of the intersections; and performing, in accordance with the pixel grouping condition, fourth image processing on non-triangular parts in the third image processing result, so as to obtain a fourth image processing result corresponding to the third image processing result, in which the fourth image processing includes segmentation processing, classification processing, and gradient color rendering, and the fourth image processing result includes a target rendered image corresponding to the target image. As can be seen, by implementing the present disclosure, the target image can be automatically converted into the grayscale image after acquiring the target image to be processed, which removes the color interference existing in the target image, and reduces the amount of data processing for the target image, i.e., facilitates to improving the computational efficiency in the subsequent processing of the target image; then, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model; thereafter, for each of the plurality of triangular patches in the second image processing result, the determination and connection of the section intersections are performed with the predetermined section as a reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches; and finally, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

### BRIEF DESCRIPTION OF THE DRAWINGS

In order to illustrate the technical solutions of the embodiments of the present disclosure more clearly, the following drawings are briefly described as required in the context of the embodiments. Obviously, the following drawings illustrate only some of the embodiments of the present disclosure. Other relevant drawings may be obtained on the basis of these drawings without any creative effort by those skilled in the art.

FIG. 1 shows a schematic flow diagram of a method for plane segmentation of a three-dimensional rendering gradient multi-level plane disclosed according to an embodiment of the present disclosure;

FIG. 2 is a schematic flow diagram of another method for plane segmentation of a three-dimensional rendering gradient multi-level plane disclosed according to an embodiment of the present disclosure;

FIG. 3 shows a schematic diagram of an apparatus for plane segmentation of a three-dimensional rendering gradient multi-level plane disclosed according to an embodiment of the present disclosure;

FIG. 4 shows a schematic diagram of another apparatus for plane segmentation of a three-dimensional rendering gradient multi-level plane disclosed according to an embodiment of the present disclosure;

FIG. 5 shows schematic diagrams of an operation effect of a kind of second image processing disclosed according to an embodiment of the present disclosure;

FIG. 6 shows schematic diagrams of another operation effect of a kind of second image processing disclosed according to an embodiment of the present disclosure;

FIG. 7 shows schematic diagrams of two-dimensional and three-dimensional effect drawings of the segmentation processing result corresponding to the third image processing result disclosed according to an embodiment of the present disclosure;

FIG. 8 shows a schematic diagram of two-dimensional and three-dimensional effect drawings corresponding to the target closed surfaces disclosed according to an embodiment of the present disclosure; and

FIG. 9 shows a schematic diagram illustrating an operation of performing a gradient color rendering on each of the target closed surfaces disclosed according to an embodiment of the present disclosure.

### DETAILED DESCRIPTION

For a better understanding of the solutions of the present disclosure by those skilled in the art, the technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments obtained by those skilled in the art without inventive effort fall within the scope of protection of the present disclosure.

The terms “first”, “second”, and the like in the specification, the claims and the above-mentioned drawings of the present disclosure are used to identify different objects and are not intended to describe a particular sequence. Additionally, the terms “comprise” and “include”, and any derivatives and conjugations thereof, are intended to cover non-exclusive inclusion. For example, a process, method, apparatus, product, or device that includes a series of steps or units is not limited to the listed steps or units, but optionally also includes steps or units that are not listed, or optionally also includes other steps or units that are inherent to those processes, methods, products, or devices.

The term “embodiment” herein means that a particular feature, structure or characteristic described in conjunction with an embodiment may be included in at least one embodiment of the present disclosure. The presence of the term in various places in the specification does not necessarily indicate the same embodiment, nor is it a separate or alternative embodiment that is mutually exclusive with other embodiments. It is understood, both explicitly and implicitly, by those skilled in the art that the embodiments described herein may be combined with other embodiments.

Disclosed in the present disclosure is a method and an apparatus for plane segmentation of a three-dimensional rendering gradient multi-level plane, in which the target image can be automatically converted into the grayscale image after acquiring the target image to be processed, which removes the color interference existing in the target image, and reduces the amount of data processing for the target image, i.e., facilitates to improving the computational efficiency in the subsequent processing of the target image; then, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model; thereafter, for each of the plurality of triangular patches in the second image processing result, the determination and connection of the section intersections are performed with the predetermined section as a reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches; and finally, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images. Detailed descriptions are provided respectively as follows.

### First Embodiment

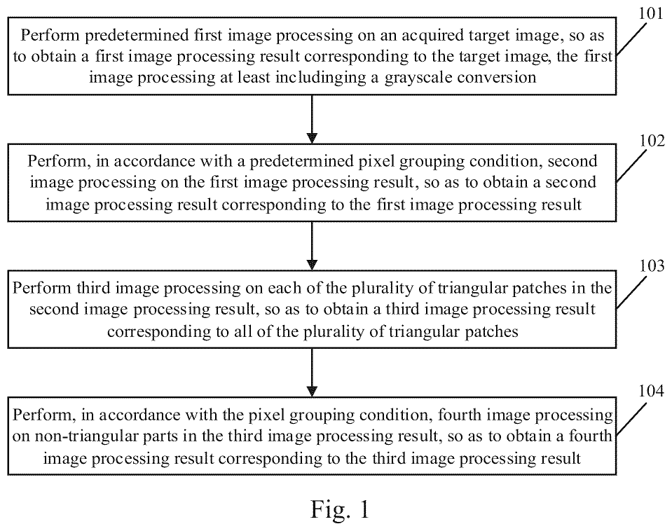

Referring to FIG. 1, FIG. 1 shows a schematic flow diagram of a method for plane segmentation of a three-dimensional rendering gradient multi-level plane disclosed according to an embodiment of the present disclosure. The method for plane segmentation of the three-dimensional rendering gradient multi-level plane described in FIG. 1 may be applied in an apparatus for plane segmentation of the three-dimensional rendering gradient multi-level plane, which is not limited in an embodiment of the present disclosure. As shown in FIG. 1, the method for plane segmentation of the three-dimensional rendering gradient multi-level plane may include the following steps:

In step 101, predetermined first image processing is performed on an acquired target image, so as to obtain a first image processing result corresponding to the target image. The first image processing at least includes a grayscale conversion.

In the embodiment of the present disclosure, before step 101 of the predetermined first image processing being performed on the acquired target image, the method further includes:

It is judged whether the target image is a grayscale image, step 101 is triggered to be performed if a judgement result is no, the target image is updated into the first image processing result and step 102 is triggered to be performed if the judgement result is yes.

In the embodiment of the present disclosure, when a processing space corresponding to the processing target image is a RGB space, a grayscale conversion formula corresponding to the grayscale conversion is specified as follows:

$$G = 0.299 \cdot {I}_{r} + 0.5 \; 87 \cdot {I}_{g} + 0.1 \; 14 \cdot {I}_{b}$$

where, Iᵣ, I_{g}, and I_{b} represent R, G, and B channel images in the RGB space, respectively, and G corresponds to a grayscale image after performing the grayscale conversion on the target image; and
when the processing space corresponding to the processing target image is a YUV space, the grayscale conversion formula corresponding to the grayscale conversion is specified as follows:

$$G = I\_y$$

where, I_y represent a Y channel in the YUV space.

In step 102, second image processing is performed on the first image processing result in accordance with a predetermined pixel grouping condition, so as to obtain a second image processing result corresponding to the first image processing result.

In an embodiment of the present disclosure, the second image processing includes three-dimensional projection and pixel grouping, and the second image processing result includes a plurality of triangular patches.

In step 103, third image processing is performed on each of the plurality of triangular patches in the second image processing result, so as to obtain a third image processing result corresponding to all of the plurality of triangular patches.

In the embodiment of the present disclosure, the third image processing includes determination of vertexes for each of the plurality of triangular patches, determination of intersections between a plane where each of the plurality of triangular patches is located and a predetermined section, and connection of the intersections.

In step 103, fourth image processing is performed on non-triangular parts in the third image processing result in accordance with the pixel grouping condition, so as to obtain a fourth image processing result corresponding to the third image processing result.

In the embodiment of the present disclosure, the fourth image processing includes segmentation processing, classification processing, and gradient color rendering, and the fourth image processing result includes a target rendered image corresponding to the target image.

As can be seen, by implementing the plane segmentation method for three-dimensional rendering of the gradient multi-level planes described in FIG. 1, the target image can be automatically converted into the grayscale image after acquiring the target image to be processed, which removes the color interference existing in the target image, and reduces the amount of data processing for the target image, i.e., facilitates to improving the computational efficiency in the subsequent processing of the target image; then, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model; thereafter, for each of the plurality of triangular patches in the second image processing result, the determination and connection of the section intersections are performed with the predetermined section as a reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches; and finally, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

In an optional embodiment, step 102 in which the second image processing is performed on the first image processing result in accordance with a predetermined pixel grouping condition, so as to obtain a second image processing result corresponding to the first image processing result specifically includes:

A stereo model is constructed, and then a three-dimensional coordinate system matched with the stereo model is established. The first image processing result includes a grayscale image corresponding to the target image, the three-dimensional coordinate system takes a length of the grayscale image as a first axis, a width of the grayscale image as a second axis, and a grayscale value of the grayscale image as a third axis. The first axis and the second axis are in a same foundation plane, and the third axis is perpendicular to the foundation plane.

The first image processing result is projected onto the three-dimensional coordinate system, so as to obtain a three-dimensional projection result corresponding to the first image processing result. The three-dimensional projection result consists of a plurality of three-dimensional pixels. The three-dimensional projection result includes a three-dimensional projection image and a two-dimensional view image both corresponding to the grayscale image, and the two-dimensional view image is obtained by projecting all of the plurality of three-dimensional pixels onto the foundation plane;
pixel division is performed on all of the plurality of three-dimensional pixels in the two-dimensional view image, so as to obtain a plurality of quadrangles. Each of the plurality of quadrangles consists of four of the plurality of three-dimensional pixels and all of the plurality of quadrangles do not overlap each other.
for each of the plurality of quadrangles, a diagonal distance corresponding to any two diagonal pixels in the respective quadrangle is calculated, a target diagonal distance from the two diagonal distances corresponding to the quadrangle is selected in accordance with a predetermined pixel grouping requirement, and the two diagonal pixels corresponding to the target diagonal distances are connected as a diagonal connection result corresponding to the quadrangle. The diagonal pixels are the three-dimensional pixels in the quadrangles at diagonal positions.

The diagonal connection results corresponding to all of the plurality of quadrangles are determined as the second image processing result corresponding to the first image processing result.

In the optional embodiment, the above three-dimensional coordinate system takes the length of the grayscale image as the first axis, the width of the grayscale image as the second axis, and the grayscale value of the grayscale image as the third axis, and in practical application, takes the length of the grayscale image as the x-axis, the width of the grayscale image as the y-axis, and the grayscale value of the grayscale image as the z-axis. Correspondingly, the foundation plane refers to a plane with z-axis coordinate of zero in the three-dimensional coordinate system.

In the optional embodiment, referring to FIG. 5, FIG. 5 shows schematic diagrams of an operation effect of a kind of second image processing disclosed according to an embodiment of the present disclosure. In the above step of the pixel division being performed on all of the three-dimensional pixels in the two-dimensional view image, so as to obtain a plurality of quadrangles, the plurality of quadrangles are shown as the left diagram of FIG. 5. Further, in the above step of the two diagonal pixels corresponding to the target diagonal distances being connected, the effect drawing of the second image processing result finally obtained is shown as the right diagram of FIG. 5.

In the optional embodiment, it is to be noted that, in the left and right diagrams of FIG. 5, the solid lines represent parts located in or above the foundation plane and the dashed lines represents parts located below the foundation plane.

As can be seen, in the optional embodiment, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; and at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model.

In another optional embodiment, the above step of the target diagonal distance from the two diagonal distances corresponding to the quadrangle being selected in accordance with a predetermined pixel grouping requirement specifically includes:

A pixel attribute of each of the diagonal pixels is determined in accordance with a corresponding grayscale value of each of the diagonal pixels. The pixel attribute includes a negative attribute or a positive attribute. The diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute.

Two diagonal pixels in the quadrangle having the same pixel attributes are identified as a first pixel pair, and two diagonal pixels in the quadrangle having different pixel attributes are identified as a second pixel pair; and the quadrangle includes a first diagonal distance and a second diagonal distance.

The second diagonal distance is determined as the target diagonal distance if the quadrangle satisfies a predetermined first grouping condition and the first diagonal distance is greater than or equal to the second diagonal distance.

The first diagonal distance is determined as the target diagonal distance if the quadrangle satisfies a predetermined second grouping condition and the first diagonal distance is less than the second diagonal distance.
the quadrangle satisfies the first grouping condition specifically in that the quadrangle has both the first pixel pair and the second pixel pair, and the second grouping condition is opposite to the first grouping condition.

In the optional embodiment, specifically, corresponding to the foregoing description, in the three-dimensional coordinate system, it is correspondingly indicated that the z-axis coordinate of the diagonal pixel is a negative number when the pixel attribute of the diagonal pixel is the negative attribute, and it is correspondingly indicated that the z-axis coordinate of the diagonal pixels is either zero or a positive number when the pixel attribute of the diagonal pixel is the positive attribute.

In the optional embodiment, it is to be noted that the first diagonal distance is determined as the target diagonal distance if the quadrangle satisfies a predetermined second grouping condition and the first diagonal distance is less than the second diagonal distance; and
the second diagonal distance is determined as the target diagonal distance if the quadrangle satisfies a predetermined first grouping condition and the first diagonal distance is greater than or equal to the second diagonal distance.

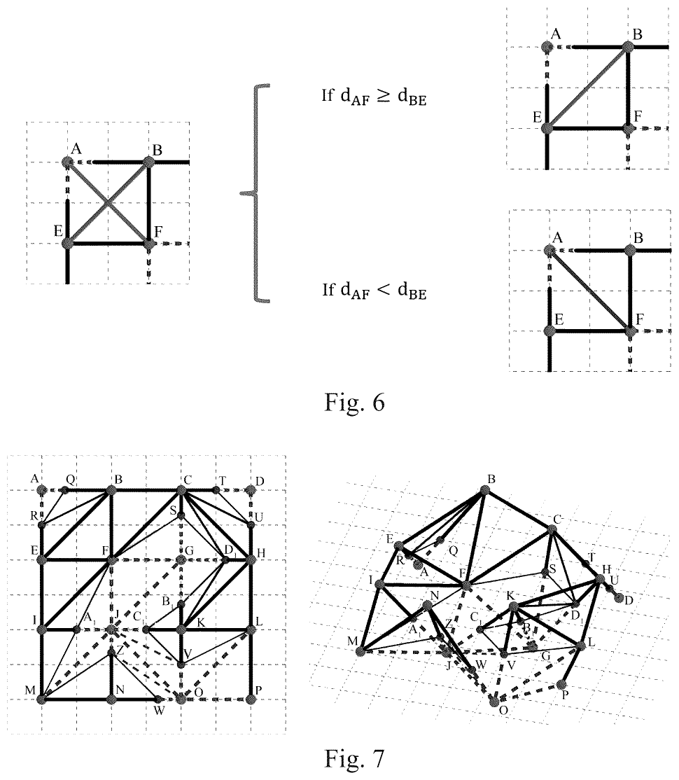

In the optional embodiment, for the setting of the first grouping condition as well as the second grouping condition, referring to FIG. 6, FIG. 6 is a schematic diagram of the operation effect of another kind of second image processing disclosed according to an embodiment of the present disclosure. As shown in the left diagram of FIG. 6, the two-dimensional viewing plane includes a first pixel pair BE and its corresponding first diagonal distance d_{BE}, a second pixel pair AF and its corresponding second diagonal distance d_{AF}. At this time, the quadrangle satisfies the predetermined first grouping condition and the first diagonal distance is less than the second diagonal distance (corresponding to d_{AF}≥d_{BE}), so that the first diagonal distance d_{BE} is selected as the target diagonal distance. The case where the quadrangle satisfies the second grouping condition is similar to the case where the quadrangle satisfies the first grouping condition, which can be seen in FIG. 6 and will not be repeated herein.

As can be seen, in the optional embodiment, it is possible to automatically determine the pixel attribute of each of the diagonal pixels in accordance with the gray value of the diagonal pixels, and then accurately determine the target diagonal distance in accordance with different grouping conditions satisfied by each of the quadrangles, which improves the accuracy of determining the target diagonal distance and its corresponding diagonal pixel.

In the optional embodiment, further, the above step of the diagonal distance corresponding to any two diagonal pixels in the quadrangle being calculated specifically includes:

For each of the plurality of quadrangles, a three-dimensional coordinate corresponding to each of the three-dimensional pixels in the quadrangle is identified, and, at the same time, two of the three-dimensional pixels in the quadrangle at diagonal positions are identified as a diagonal pixel pair. the diagonal pixel pair includes two diagonal pixels.

For each of the diagonal pixel pairs in each of the plurality of quadrangles, a distance between the two diagonal pixels in the diagonal pixel pair in accordance with a predetermined two-point distance formula is calculated, so as to obtain the diagonal distance corresponding to the two diagonal pixels in the diagonal pixel pair.

In the optional embodiment, the two-point distance formula is specified as follows:

$$d = \sqrt{{( {x}_{1} - {x}_{2} )}^{2} + {( {y}_{1} - {y}_{2} )}^{2} + {( {z}_{1} - {z}_{2} )}^{2}}$$

where, d is the diagonal distance corresponding to two diagonal pixels; and pixels coordinates of the diagonal pixel pair are (x₁, y₁, z₁) and (x₂, y₂, z₂).

As can be seen, in the optional embodiment, the calculation of the gray value of the third dimension of the three-dimensional pixel is introduced by the predetermined distance calculation formula, thereby improving the calculation accuracy of the distance between two three-dimensional pixels (diagonal pixels).

In yet another optional embodiment, the above step of the third image processing being performed on each of the plurality of triangular patches in the second image processing result, so as to obtain a third image processing result corresponding to all of the plurality of triangular patches specifically includes:

The target section and its corresponding plane equation are determined. The target section is the foundation plane or a plane parallel to the foundation plane.

For each of the plurality of triangular patches in the second image processing result, a vertex coordinate corresponding to each of triangular vertexes in the triangular patch is determined in accordance with a preset fixed point function.

Intersection coordinates corresponding to two target intersections between the target section and the triangular patch are calculated in accordance with the plane equation and the vertex coordinate corresponding to each of the triangular vertexes in the triangular patch, and then the two target intersections are connected, so as to obtain an intersection connection result corresponding to the triangular patch.

All of the intersection connection results and all of the target intersections both corresponding to all of the plurality of triangular patches are determined as the third image processing result.

In the optional embodiment, the plane equation corresponding to the target section is: α·x+β·y+γ·z+δ=0, a function is defined as F(x, y, z)=α·x+β·y+γ·z+δ, and the points are A=(x_{A}, y_{A}, z_{A}), B=(x_{B}, y_{B}, z_{B}), and E=(x_{E}, y_{E}, z_{E}). And Then Q=(x_{Q}, y_{Q}, z_{Q}), R=(x_{R}, y_{R}, z_{R}); where the points A, B, and C are the three vertexes of any one triangular patch of the plurality of triangular patches; Q, and R are the intersections of the triangular patch and the target section; α, β, γ, and δ in the plane equation are equation coefficients, which are calculated by combining the coordinates of the three three-dimensional pixels, which are co-planar but non-collinear, selected from the practical application scenario with the plane equation.

Further, the formula for the point Q in the two intersections is as follows:

$$\{ \begin{matrix}{x}_{Q} = {x}_{A} + \frac{F ( A )}{F ( A ) - F ( B )} \cdot ( {x}_{B} - {x}_{A} ) \\ {y}_{Q} = {y}_{A} + \frac{F ( A )}{F ( A ) - F ( B )} \cdot ( {y}_{B} - {y}_{A} ) \\ {z}_{Q} = {z}_{A} + \frac{F ( A )}{F ( A ) - F ( B )} \cdot ( {z}_{B} - {z}_{A} )\end{matrix}$$

The formula for the point R in these two intersections is as follows:

$$\{ \begin{matrix}{x}_{R} = {x}_{A} + \frac{F ( A )}{F ( A ) - F ( E )} \cdot ( {x}_{E} - {x}_{A} ) \\ {y}_{R} = {y}_{A} + \frac{F ( A )}{F ( A ) - F ( E )} \cdot ( {y}_{E} - {y}_{A} ) \\ {z}_{R} = {z}_{A} + \frac{F ( A )}{F ( A ) - F ( E )} \cdot ( {z}_{E} - {z}_{A} )\end{matrix}$$

As can be seen, in the optional embodiment, for each of the plurality of triangular patches in the second image processing result, the determination and connection of the section intersections are performed with the predetermined section as the reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches.

### Second Embodiment

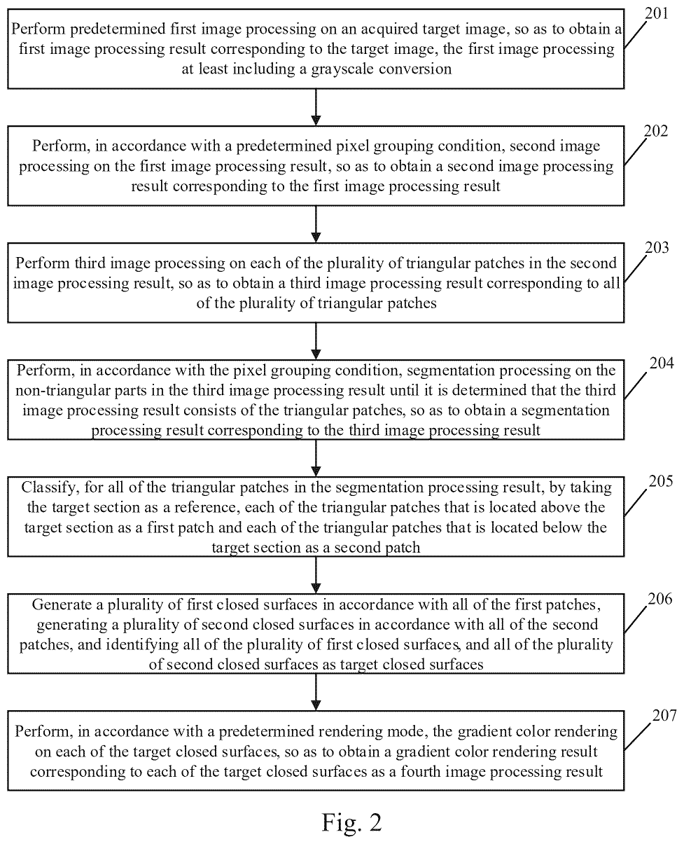

Referring to FIG. 2, FIG. 2 is a schematic flow diagram of another method for plane segmentation of a three-dimensional rendering gradient multi-level plane disclosed according to an embodiment of the present disclosure. The method for plane segmentation of the three-dimensional rendering gradient multi-level plane described in FIG. 2 may be applied in an apparatus for plane segmentation of the three-dimensional rendering gradient multi-level plane, which is not limited in an embodiment of the present disclosure. As shown in FIG. 2, the method for plane segmentation of the three-dimensional rendering gradient multi-level plane may include the following steps:

In step 201, predetermined first image processing is performed on an acquired target image, so as to obtain a first image processing result corresponding to the target image. The first image processing at least includes a grayscale conversion.

in step 202, second image processing is performed on the first image processing result in accordance with a predetermined pixel grouping condition, so as to obtain a second image processing result corresponding to the first image processing result.

In step 203, third image processing is performed on each of the plurality of triangular patches in the second image processing result, so as to obtain a third image processing result corresponding to all of the plurality of triangular patches.

In the embodiment of the present disclosure, the third image processing includes determination of vertexes for each of the plurality of triangular patches, determination of intersections between a plane where each of the plurality of triangular patches is located and a predetermined section, and connection of the intersections.

In step 204, segmentation processing is performed on the non-triangular parts in the third image processing result in accordance with the pixel grouping condition until it is determined that the third image processing result consists of the triangular patches, so as to obtain a segmentation processing result corresponding to the third image processing result.

In the embodiment of the present disclosure, in the third image processing result obtained through the processing of steps 201 to 203, it is not possible to obtain the third image processing result that only include triangular patches directly after performing the division of the triangular patches. Thus, it is necessary to provide the step of the segmentation processing to convert all of the polygons in the third image processing result into triangular patches that are convenient for subsequent processing.

In the embodiment of the present disclosure, referring to FIG. 7, FIG. 7 shows schematic diagrams of two-dimensional and three-dimensional effect drawings of the segmentation processing result corresponding to the third image processing result disclosed according to an embodiment of the present disclosure. As shown in FIG. 7, the left diagram of FIG. 7 shows a two-dimensional effect drawing of the segmentation processing result, and the right diagram of FIG. 7 shows a three-dimensional effect drawing of the segmentation processing result.

In step 205, for all of the triangular patches in the segmentation processing result, by taking the target section as a reference, each of the triangular patches that is located above the target section is classified as a first patch, and each of the triangular patches that is located below the target section is classified as a second patch;

In step 206, a plurality of first closed surfaces are generated in accordance with all of the first patches, a plurality of second closed surfaces are generated in accordance with all of the second patches, and all of the plurality of first closed surfaces and all of the plurality of second closed surfaces are identified as target closed surfaces.

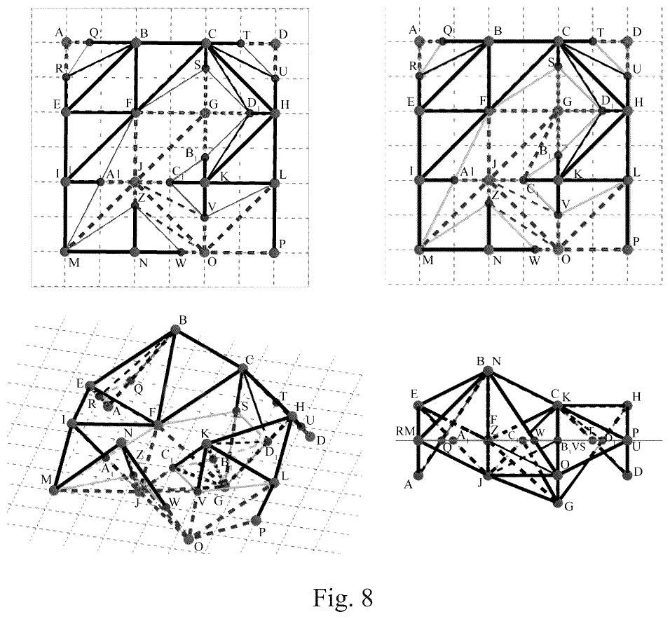

In the embodiment of the present disclosure, referring to FIG. 8, FIG. 8 shows a schematic diagram of two-dimensional and three-dimensional effect drawings corresponding to the target closed surfaces disclosed according to an embodiment of the present disclosure. As shown in FIG. 8, the two diagrams at the top of FIG. 8 and the right diagram at the bottom of FIG. 8 show two-dimensional effect drawings of all of the target closed surfaces, and the left diagram at the bottom of FIG. 8 shows a three-dimensional effect drawing of all of the target closed surfaces.

In step 207, the gradient color rendering is performed on each of the target closed surfaces in accordance with a predetermined rendering mode, so as to obtain a gradient color rendering result corresponding to each of the target closed surfaces as a fourth image processing result.

In the present embodiment of the disclosure, regarding other descriptions of steps 201 to 203, please refer to the other detailed descriptions of steps 101 to 103 in the first embodiment, which is not repeated in the present embodiment of the disclosure.

As can be seen, the implementation of the method for plane segmentation of the three-dimensional rendering gradient multi-level plane described in FIG. 2, through the setup of segmentation processing, classification processing, and gradient color rendering, is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

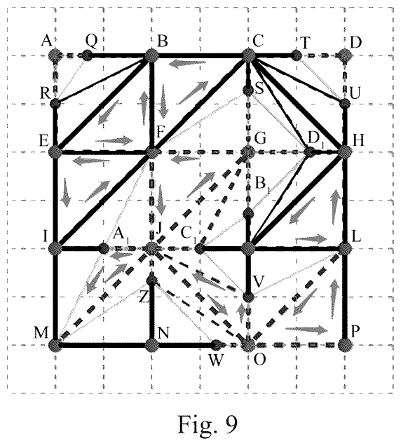

In an optional embodiment, referring to FIG. 9, FIG. 9 shows a schematic diagram illustrating an operation of performing a gradient color rendering on each of the target closed surfaces disclosed according to an embodiment of the present disclosure. As shown in FIG. 9, the step of the gradient color rendering being performed on each of the target closed surfaces in accordance with a predetermined rendering mode, so as to obtain the gradient color rendering result corresponding to each of the target closed surfaces specifically includes:

A two-dimensional surface projection corresponding to each of the target closed surfaces in the foundation plane is obtained. The two-dimensional surface projection includes a first subsurface projection corresponding to each of the plurality of first closed surfaces, and a second subsurface projection corresponding to each of the plurality of second closed surfaces.

In accordance with a predetermined first color system, the gradient color rendering for each of the first subsurface projections is performed with a counterclockwise direction as a rendering direction, so as to obtain a first rendering result corresponding to each of the first subsurface projections.

In accordance with a predetermined second color system, the gradient color rendering for each of the second subsurface projections is performed with the counterclockwise direction as the rendering direction, so as to obtain a second rendering result corresponding to each of the second subsurface projections.

All of the first rendering results and all of the second rendering results are determined as a gradient color rendering result.

As can be seen, in the optional embodiment, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

### Third Embodiment

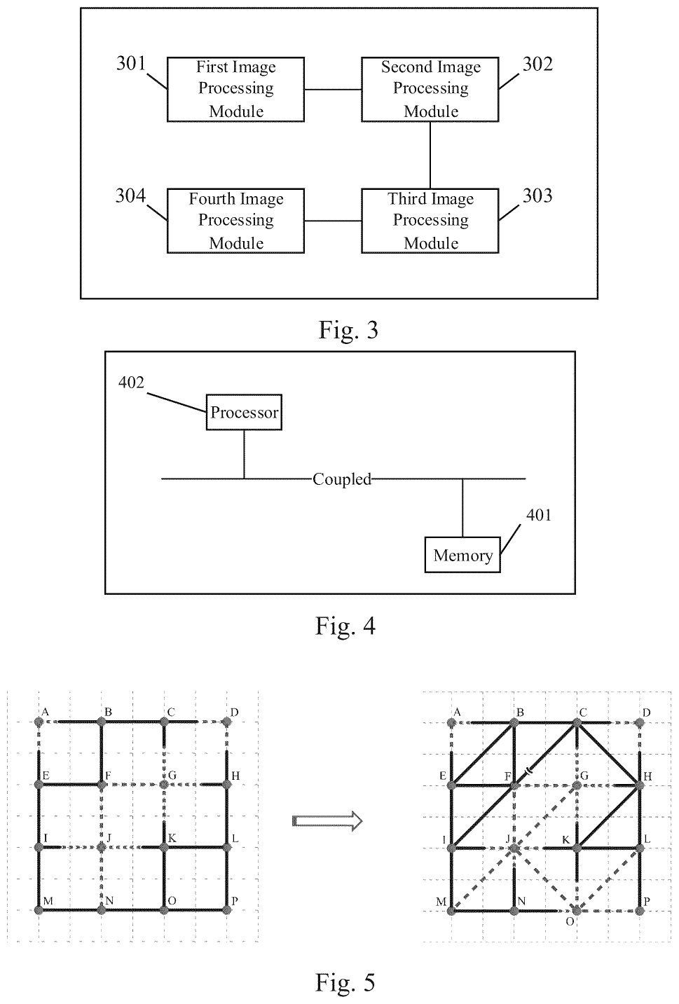

Referring to FIG. 3, FIG. 3 shows a schematic diagram of an apparatus for plane segmentation of a three-dimensional rendering gradient multi-level plane disclosed according to an embodiment of the present disclosure. The apparatus for plane segmentation of the three-dimensional rendering gradient multi-level plane may be a terminal, an apparatus, a system, or a server for plane segmentation of the three-dimensional rendering gradient multi-level plane. The server may be a local server, a remote server, or a cloud server. When the server is a non-cloud server, the non-cloud server is able to in communicating connection with the cloud server, which is not limited in an embodiment of the present disclosure. As shown in FIG. 3, the apparatus for plane segmentation of the three-dimensional rendering gradient multi-level plane may include a first image processing module 301, a second image processing module 302, a third image processing module 303, and a fourth image processing module 304.

The first image processing module 301 is configured to perform predetermined first image processing on an acquired target image, so as to obtain a first image processing result corresponding to the target image. The first image processing at least includes a grayscale conversion.

The second image processing module 302 is configured to perform second image processing on the first image processing result in accordance with a predetermined pixel grouping condition, so as to obtain a second image processing result corresponding to the first image processing result. The second image processing includes three-dimensional projection and pixel grouping, and the second image processing result includes a plurality of triangular patches.

The third image processing module 303 is configured to perform third image processing on each of the plurality of triangular patches in the second image processing result, so as to obtain a third image processing result corresponding to all of the plurality of triangular patches. The third image processing includes determination of vertexes for each of the plurality of triangular patches, determination of intersections between a plane where each of the plurality of triangular patches is located and a predetermined section, and connection of the intersections.

The fourth image processing module 304 is configured to perform fourth image processing on non-triangular parts in the third image processing result in accordance with the pixel grouping condition, so as to obtain a fourth image processing result corresponding to the third image processing result. The fourth image processing includes segmentation processing, classification processing, and gradient color rendering, and the fourth image processing result includes a target rendered image corresponding to the target image.

As can be seen, by implementing the apparatus for plane segmentation of a three-dimensional rendering gradient multi-level plane, in which the target image can be automatically converted into the grayscale image after acquiring the target image to be processed, which removes the color interference existing in the target image, and reduces the amount of data processing for the target image, i.e., facilitates to improving the computational efficiency in the subsequent processing of the target image; then, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model; thereafter, for each of the plurality of triangular patches in the second image processing result, the determination and connection of the section intersections are performed with the predetermined section as a reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches; and finally, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

In an optional embodiment, the second image processing module 302 performing second image processing on the first image processing result in accordance with a predetermined pixel grouping condition, so as to obtain a second image processing result corresponding to the first image processing result specifically includes:
constructing a stereo model, and then establishing a three-dimensional coordinate system matched with the stereo model, the first image processing result including a grayscale image corresponding to the target image, the three-dimensional coordinate system taking a length of the grayscale image as a first axis, a width of the grayscale image as a second axis, and a grayscale value of the grayscale image as a third axis, the first axis and the second axis are in a same foundation plane, and the third axis being perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result including a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, each of the plurality of quadrangles consisting of four of the plurality of three-dimensional pixels and all of the plurality of quadrangles do not overlap each other;
calculating, for each of the plurality of quadrangles, a diagonal distance corresponding to any two diagonal pixels in the quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangles at diagonal positions; and
determining the diagonal connection results corresponding to all of the plurality of quadrangles as the second image processing result corresponding to the first image processing result.

As can be seen, in the optional embodiment, the three-dimensionalization of the first image processing result is achieved by the setup of the three-dimensional projection, and, compared with operating directly on the two-dimensional image, there is a higher image processing efficiency and better image processing effect by adopting the three-dimensional processing technology; and at the same time, the plurality of triangular patches are obtained by the setup of the pixel grouping to process the first image processing result, and the execution of the triangular grouping (corresponding to the pixel grouping) in the three-dimensional model can further refine the surface structure of the three-dimensional model corresponding to the second image processing, and facilitates to optimizing the storage and rendering process of the three-dimensional model, thereby further improving the model processing efficiency of the three-dimensional model.

In another optional embodiment, the second image processing module 302 selecting a target diagonal distance from the two diagonal distances corresponding to the quadrangle in accordance with a predetermined pixel grouping requirement specifically includes the following steps:
determining a pixel attribute of each of the diagonal pixels in accordance with a corresponding grayscale value of each of the diagonal pixels, in which the pixel attribute includes a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with the same pixel attributes as a first pixel pair, and identifying two of the diagonal pixels of the quadrangle with different pixel attributes as a second pixel pair, the quadrangle including a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance.
the quadrangle satisfies the first grouping condition specifically in that the quadrangle has both the first pixel pair and the second pixel pair, and the second grouping condition is opposite to the first grouping condition.

As can be seen, in the optional embodiment, it is possible to automatically determine the pixel attribute of each of the diagonal pixels in accordance with the gray value of the diagonal pixels, and then accurately determine the target diagonal distance in accordance with different grouping conditions satisfied by each of the quadrangles, which improves the accuracy of determining the target diagonal distance and its corresponding diagonal pixel.

In the optional embodiment, the second image processing module 302 calculating, for each of the plurality of quadrangles, the diagonal distance corresponding to any two diagonal pixels in the quadrangle specifically includes the following steps:
identifying, for each of the plurality of quadrangles, a three-dimensional coordinate corresponding to each of the three-dimensional pixels in the quadrangle, and, at the same time, identifying two of the three-dimensional pixels in the quadrangle at diagonal positions as a diagonal pixel pair, the diagonal pixel pair including two diagonal pixels; and
calculating, for each of the diagonal pixel pairs in each of the plurality of quadrangles, a distance between the two diagonal pixels in the diagonal pixel pair in accordance with a predetermined two-point distance formula, so as to obtain the diagonal distance corresponding to the two diagonal pixels in the diagonal pixel pair.

As can be seen, in the optional embodiment, the calculation of the gray value of the third dimension of the three-dimensional pixel is introduced by the predetermined distance calculation formula, thereby improving the calculation accuracy of the distance between two three-dimensional pixels (diagonal pixels).

In yet another optional embodiment, the second image processing module 302 performing the third image processing on each of the plurality of triangular patches in the second image processing result, so as to obtain the third image processing result corresponding to all of the plurality of triangular patches specifically includes the following steps:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

As can be seen, in the optional embodiment, for each of the plurality of triangular patches in the second image processing result, the determination and connection of the section intersections are performed with the predetermined section as the reference, the boundary points on the segmentation plane (the preset section) are supplemented through the setup of the third image processing, so as to generate different categories of triangular patches (corresponding to the third image processing result) on the two sides of the plane, and then accuracy matching processing is performed for different categories of the triangular patches, which improves the accuracy of the subsequent image processing for different categories of the triangular patches.

In another optional embodiment, the fourth image processing module 304 performing a fourth image processing on non-triangular parts in the third image processing result, in accordance with the pixel grouping condition, so as to obtain a fourth image processing result corresponding to the third image processing result specifically includes the following steps:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

As can be seen, in the optional embodiment, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

In another optional embodiment, the fourth image processing module 304 performing, in accordance with the predetermined rendering mode, the gradient color rendering on each of the target closed surfaces, so as to obtain the gradient color rendering result corresponding to each of the target closed surfaces specifically includes the following steps:
obtaining a two-dimensional surface projection corresponding to each of the target closed surfaces in the foundation plane, the two-dimensional surface projection including a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.

As can be seen, in the optional embodiment, through the setup of segmentation processing, classification processing, and gradient color rendering, it is capable of generating multi-layer customized gradient effects by using a very small amount of vertex space without changing the real-time rendering of gradient color of the triangular patch and the three-dimensional appearance of surfaces, which improves the flexibility and accuracy of processing and rendering gradient multi-level images.

### Fourth Embodiment

Referring to FIG. 4, FIG. 4 shows a schematic diagram of another apparatus for plane segmentation of a three-dimensional rendering gradient multi-level plane disclosed according to an embodiment of the present disclosure. As shown in FIG. 4, the apparatus for plane segmentation of the three-dimensional rendering gradient multi-level plane may include:
a memory 401, memorized with an executable code; and
a processor 402, coupled with the memory 401.

The processor invokes the executable code memorized in the memory to perform the method for plane segmentation of the three-dimensional rendering gradient multi-level plane described in the first embodiment or the second embodiment of the present disclosure.

### Fifth Embodiment

Disclosed in the present embodiment of the disclosure is a non-transitory computer memory medium. The non-transitory computer memory medium memorizes computer instructions. When invoked, the computer instructions are configured to cause steps in the method for plane segmentation of the three-dimensional rendering gradient multi-level plane described in the first embodiment or the second embodiment of the present disclosure to be performed.

### Sixth Embodiment

Disclosed in the present embodiment of the disclosure is a computer program product. The computer program product includes a non-transitory computer memory medium memorized with a computer program. The computer program may be operated to enable the computer to perform steps in the method for plane segmentation of the three-dimensional rendering gradient multi-level plane described in the first embodiment or the second embodiment.

The aforementioned described embodiment of the apparatus is only illustrative. The modules described as separate components may or may not be physically separated, and the modules used as components for display may or may not be physical modules, that is, they may be located in the same place or may be distributed to a plurality of network modules. Some or all of these modules may be selected in accordance with practical demands to achieve the purpose of the solution of the present embodiment. It may be understood and performed by a person of ordinary skill in the art without inventive effort.

With the specific description of the above embodiments, it is clear to those skilled in the art that the various implementations may be implemented with the aid of software plus the necessary common hardware platform, and admittedly, with the aid of hardware. in accordance with such an understanding, the above technical solutions that essentially or contribute to the prior art may be embodied in the form of a software product which may be memorized in a non-transitory computer memory medium, and the non-transitory memory readable medium includes Read-Only Memory, Random Access Memory, Programmable Read-only Memory, Erasable Programmable Read Only Memory, One-time Programmable Read-Only Memory, Electrically-Erasable Programmable Read-Only Memory, Compact Disc Read-Only Memory, other Compact Disc Memory, Disk Memory, Tape Memory or any other non-transitory computer-readable medium that may be used to carry or memorize data.

Finally, it should be noted that the method, apparatus and system for plane segmentation of the three-dimensional rendering gradient multi-level plane disclosed in the embodiments of the present disclosure are only preferred embodiments of the present disclosure, and are only used to illustrate the technical solutions of the present disclosure, but not to limit them. Despite the detailed description of the disclosure with reference to the aforementioned embodiments, it should be understood, by those skilled in the art, that the technical solutions recorded in the aforementioned embodiments may still be modified, or equivalent substitutions for some of the technical features thereof may be made, but the essence of the corresponding technical solutions of these modifications or substitutions is without departing from the spirit and scope of the technical solutions of the various embodiments of the disclosure.

1. A method for plane segmentation of a three-dimensional rendering gradient multi-level plane, wherein the method comprises:
performing predetermined first image processing on an acquired target image, so as to obtain a first image processing result corresponding to the target image, the first image processing at least comprising a grayscale conversion;
performing, in accordance with a predetermined pixel grouping condition, second image processing on the first image processing result, so as to obtain a second image processing result corresponding to the first image processing result, the second image processing comprising three-dimensional projection and pixel grouping, and the second image processing result comprising a plurality of triangular patches;
performing third image processing on each of the plurality of triangular patches in the second image processing result, so as to obtain a third image processing result corresponding to all of the plurality of triangular patches, the third image processing comprising determination of vertexes for each of the plurality of triangular patches, determination of intersections between a plane where each of the plurality of triangular patches is located and a predetermined section, and connection of the intersections; and
performing, in accordance with the pixel grouping condition, fourth image processing on non-triangular parts in the third image processing result, so as to obtain a fourth image processing result corresponding to the third image processing result, the fourth image processing comprising segmentation processing, classification processing, and gradient color rendering, and the fourth image processing result comprising a target rendered image corresponding to the target image.

2. The method for plane segmentation of the three-dimensional rendering gradient multi-level plane according to claim 1, wherein the performing, in accordance with a predetermined pixel grouping condition, the second image processing on the first image processing result, so as to obtain the second image processing result corresponding to the first image processing result comprises:
constructing a stereo model, and then establishing a three-dimensional coordinate system matched with the stereo model, wherein the first image processing result comprises a grayscale image corresponding to the target image, the three-dimensional coordinate system takes a length of the grayscale image as a first axis, a width of the grayscale image as a second axis, and a grayscale value of the grayscale image as a third axis, the first axis and the second axis are in a same foundation plane, and the third axis is perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result comprising a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, wherein each of the plurality of quadrangles consists of four of the plurality of three-dimensional pixels and all of the plurality of quadrangles do not overlap each other;
calculating, for each of the plurality of quadrangles, a diagonal distance corresponding to any two diagonal pixels in the respective quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangle at diagonal positions; and
determining the diagonal connection results corresponding to all of the plurality of quadrangles as the second image processing result corresponding to the first image processing result.

3. The method for plane segmentation of the three-dimensional rendering gradient multi-level plane according to claim 2, wherein the selecting, in accordance with the predetermined pixel grouping requirement, the target diagonal distance from the two diagonal distances corresponding to the quadrangle comprises:
determining, in accordance with a corresponding grayscale value of each of the diagonal pixels, a pixel attribute of each of the diagonal pixels, wherein the pixel attribute comprises a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with same pixel attributes as a first pixel pair, and identifying two of the diagonal pixels of the quadrangle with different pixel attributes as a second pixel pair, the quadrangle comprising a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance,
wherein the quadrangle satisfies the first grouping condition specifically in that the quadrangle has both the first pixel pair and the second pixel pair, and the second grouping condition is opposite to the first grouping condition.

4. The method for plane segmentation of the three-dimensional rendering gradient multi-level plane according to claim 2, wherein the performing the third image processing on each of the plurality of triangular patches in the second image processing result, so as to obtain the third image processing result corresponding to all of the plurality of triangular patches comprises:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

5. The method for plane segmentation of the three-dimensional rendering gradient multi-level plane according to claim 2, wherein the performing, in accordance with the pixel grouping condition, a fourth image processing on non-triangular parts in the third image processing result, so as to obtain a fourth image processing result corresponding to the third image processing result comprises:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

6. The method for plane segmentation of the three-dimensional rendering gradient multi-level plane according to claim 5, wherein the performing, in accordance with the predetermined rendering mode, the gradient color rendering on each of the target closed surfaces, so as to obtain the gradient color rendering result corresponding to each of the target closed surfaces comprises:
obtaining a two-dimensional surface projection corresponding to each of the target closed surfaces in the foundation plane, the two-dimensional surface projection comprising a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.

7. The method for plane segmentation of the three-dimensional rendering gradient multi-level plane according to claim 2, wherein the calculating, for each of the plurality of quadrangles, the diagonal distance corresponding to any two diagonal pixels in the quadrangle comprises:
identifying, for each of the plurality of quadrangles, a three-dimensional coordinate corresponding to each of the three-dimensional pixels in the quadrangle, and, at the same time, identifying two of the three-dimensional pixels in the quadrangle at diagonal positions as a diagonal pixel pair, the diagonal pixel pair comprising two diagonal pixels; and
calculating, for each of the diagonal pixel pairs in each of the plurality of quadrangles, a distance between the two diagonal pixels in the diagonal pixel pair in accordance with a predetermined two-point distance formula, so as to obtain the diagonal distance corresponding to the two diagonal pixels in the diagonal pixel pair.

8. An apparatus for plane segmentation of a three-dimensional rendering gradient multi-level plane, comprising:
a memory, memorized with an executable code; and
a processor, coupled with the memory,
wherein the processor invokes the executable code memorized in the memory to perform a method for plane segmentation of the three-dimensional rendering gradient multi-level plane, and the method comprises:
performing predetermined first image processing on an acquired target image, so as to obtain a first image processing result corresponding to the target image, the first image processing at least comprising a grayscale conversion;
performing, in accordance with a predetermined pixel grouping condition, second image processing on the first image processing result, so as to obtain a second image processing result corresponding to the first image processing result, the second image processing comprising three-dimensional projection and pixel grouping, and the second image processing result comprising a plurality of triangular patches;
performing third image processing on each of the plurality of triangular patches in the second image processing result, so as to obtain a third image processing result corresponding to all of the plurality of triangular patches, the third image processing comprising determination of vertexes for each of the plurality of triangular patches, determination of intersections between a plane where each of the plurality of triangular patches is located and a predetermined section, and connection of the intersections; and
performing, in accordance with the pixel grouping condition, fourth image processing on non-triangular parts in the third image processing result, so as to obtain a fourth image processing result corresponding to the third image processing result, the fourth image processing comprising segmentation processing, classification processing, and gradient color rendering, and the fourth image processing result comprising a target rendered image corresponding to the target image.

9. The apparatus for plane segmentation of the three-dimensional rendering gradient multi-level plane according to claim 8, wherein the performing, in accordance with a predetermined pixel grouping condition, the second image processing on the first image processing result, so as to obtain the second image processing result corresponding to the first image processing result comprises:
constructing a stereo model, and then establishing a three-dimensional coordinate system matched with the stereo model, wherein the first image processing result comprises a grayscale image corresponding to the target image, the three-dimensional coordinate system takes a length of the grayscale image as a first axis, a width of the grayscale image as a second axis, and a grayscale value of the grayscale image as a third axis, the first axis and the second axis are in a same foundation plane, and the third axis is perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result comprising a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, wherein each of the plurality of quadrangles consists of four of the plurality of three-dimensional pixels and all of the plurality of quadrangles do not overlap each other;
calculating, for each of the plurality of quadrangles, a diagonal distance corresponding to any two diagonal pixels in the respective quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangle at diagonal positions; and
determining the diagonal connection results corresponding to all of the plurality of quadrangles as the second image processing result corresponding to the first image processing result.

10. The apparatus for plane segmentation of the three-dimensional rendering gradient multi-level plane according to claim 9, wherein the selecting, in accordance with the predetermined pixel grouping requirement, the target diagonal distance from the two diagonal distances corresponding to the quadrangle comprises:
determining, in accordance with a corresponding grayscale value of each of the diagonal pixels, a pixel attribute of each of the diagonal pixels, wherein the pixel attribute comprises a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with same pixel attributes as a first pixel pair, and identifying two of the diagonal pixels of the quadrangle with different pixel attributes as a second pixel pair, the quadrangle comprising a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance,
wherein the quadrangle satisfies the first grouping condition specifically in that the quadrangle has both the first pixel pair and the second pixel pair, and the second grouping condition is opposite to the first grouping condition.

11. The apparatus for plane segmentation of the three-dimensional rendering gradient multi-level plane according to claim 9, wherein the performing the third image processing on each of the plurality of triangular patches in the second image processing result, so as to obtain the third image processing result corresponding to all of the plurality of triangular patches comprises:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

12. The apparatus for plane segmentation of the three-dimensional rendering gradient multi-level plane according to claim 9, wherein the performing, in accordance with the pixel grouping condition, a fourth image processing on non-triangular parts in the third image processing result, so as to obtain a fourth image processing result corresponding to the third image processing result comprises:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

13. The apparatus for plane segmentation of the three-dimensional rendering gradient multi-level plane according to claim 12, wherein the performing, in accordance with the predetermined rendering mode, the gradient color rendering on each of the target closed surfaces, so as to obtain the gradient color rendering result corresponding to each of the target closed surfaces comprises:
obtaining a two-dimensional surface projection corresponding to each of the target closed surfaces in the foundation plane, the two-dimensional surface projection comprising a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.

14. The apparatus for plane segmentation of the three-dimensional rendering gradient multi-level plane according to claim 9, wherein the calculating, for each of the plurality of quadrangles, the diagonal distance corresponding to any two diagonal pixels in the quadrangle comprises:
identifying, for each of the plurality of quadrangles, a three-dimensional coordinate corresponding to each of the three-dimensional pixels in the quadrangle, and, at the same time, identifying two of the three-dimensional pixels in the quadrangle at diagonal positions as a diagonal pixel pair, the diagonal pixel pair comprising two diagonal pixels; and
calculating, for each of the diagonal pixel pairs in each of the plurality of quadrangles, a distance between the two diagonal pixels in the diagonal pixel pair in accordance with a predetermined two-point distance formula, so as to obtain the diagonal distance corresponding to the two diagonal pixels in the diagonal pixel pair.

15. A non-transitory computer memory medium, wherein, the non-transitory computer memory medium memorizes computer instructions, and the computer instructions, when invoked, are configured to cause a method for plane segmentation of a three-dimensional rendering gradient multi-level plane to be performed, and the method comprises:
performing predetermined first image processing on an acquired target image, so as to obtain a first image processing result corresponding to the target image, the first image processing at least comprising a grayscale conversion;
performing, in accordance with a predetermined pixel grouping condition, second image processing on the first image processing result, so as to obtain a second image processing result corresponding to the first image processing result, the second image processing comprising three-dimensional projection and pixel grouping, and the second image processing result comprising a plurality of triangular patches;
performing third image processing on each of the plurality of triangular patches in the second image processing result, so as to obtain a third image processing result corresponding to all of the plurality of triangular patches, the third image processing comprising determination of vertexes for each of the plurality of triangular patches, determination of intersections between a plane where each of the plurality of triangular patches is located and a predetermined section, and connection of the intersections; and
performing, in accordance with the pixel grouping condition, fourth image processing on non-triangular parts in the third image processing result, so as to obtain a fourth image processing result corresponding to the third image processing result, the fourth image processing comprising segmentation processing, classification processing, and gradient color rendering, and the fourth image processing result comprising a target rendered image corresponding to the target image.

16. The non-transitory computer memory medium according to claim 15, wherein the performing, in accordance with a predetermined pixel grouping condition, the second image processing on the first image processing result, so as to obtain the second image processing result corresponding to the first image processing result comprises:
constructing a stereo model, and then establishing a three-dimensional coordinate system matched with the stereo model, wherein the first image processing result comprises a grayscale image corresponding to the target image, the three-dimensional coordinate system takes a length of the grayscale image as a first axis, a width of the grayscale image as a second axis, and a grayscale value of the grayscale image as a third axis, the first axis and the second axis are in a same foundation plane, and the third axis is perpendicular to the foundation plane;
projecting the first image processing result onto the three-dimensional coordinate system, so as to obtain a three-dimensional projection result corresponding to the first image processing result, the three-dimensional projection result consisting of a plurality of three-dimensional pixels, the three-dimensional projection result comprising a three-dimensional projection image and a two-dimensional view image both corresponding to the grayscale image, and the two-dimensional view image being obtained by projecting all of the plurality of three-dimensional pixels onto the foundation plane;
performing pixel division on all of the plurality of three-dimensional pixels in the two-dimensional view image, so as to obtain a plurality of quadrangles, wherein each of the plurality of quadrangles consists of four of the plurality of three-dimensional pixels and all of the plurality of quadrangles do not overlap each other;
calculating, for each of the plurality of quadrangles, a diagonal distance corresponding to any two diagonal pixels in the respective quadrangle, selecting, in accordance with a predetermined pixel grouping requirement, a target diagonal distance from the two diagonal distances corresponding to the quadrangle, and connecting the two diagonal pixels corresponding to the target diagonal distances as a diagonal connection result corresponding to the quadrangle, the diagonal pixels being the three-dimensional pixels in the quadrangle at diagonal positions; and
determining the diagonal connection results corresponding to all of the plurality of quadrangles as the second image processing result corresponding to the first image processing result.

17. The non-transitory computer memory medium according to claim 16, wherein the selecting, in accordance with the predetermined pixel grouping requirement, the target diagonal distance from the two diagonal distances corresponding to the quadrangle comprises:
determining, in accordance with a corresponding grayscale value of each of the diagonal pixels, a pixel attribute of each of the diagonal pixels, wherein the pixel attribute comprises a negative attribute or a positive attribute, the diagonal pixel, in the three-dimensional projection image, is located under the foundation plane when the pixel attribute of the diagonal pixel is the negative attribute, and the diagonal pixel, in the three-dimensional projection image, is located in or above the foundation plane when the pixel attribute of the diagonal pixels is the positive attribute;
identifying two of the diagonal pixels of the quadrangle with same pixel attributes as a first pixel pair, and identifying two of the diagonal pixels of the quadrangle with different pixel attributes as a second pixel pair, the quadrangle comprising a first diagonal distance and a second diagonal distance;
determining, if the quadrangle satisfies a predetermined first grouping condition and the first diagonal distance is greater than or equal to the second diagonal distance, the second diagonal distance as the target diagonal distance; and
determining, if the quadrangle satisfies a predetermined second grouping condition and the first diagonal distance is less than the second diagonal distance, the first diagonal distance as the target diagonal distance,
wherein the quadrangle satisfies the first grouping condition specifically in that the quadrangle has both the first pixel pair and the second pixel pair, and the second grouping condition is opposite to the first grouping condition.

18. The non-transitory computer memory medium according to claim 16, wherein the performing the third image processing on each of the plurality of triangular patches in the second image processing result, so as to obtain the third image processing result corresponding to all of the plurality of triangular patches comprises:
determining a target section and a plane equation corresponding to the target section, the target section being the foundation plane or a plane parallel to the foundation plane;
determining, for each of the plurality of triangular patches in the second image processing result, a vertex coordinate corresponding to each of triangular vertexes in the triangular patch in accordance with a preset fixed point function;
calculating, in accordance with the plane equation and the vertex coordinate corresponding to each of the triangular vertexes in the triangular patch, intersection coordinates corresponding to two target intersections between the target section and the triangular patch, and then connecting the two target intersections, so as to obtain an intersection connection result corresponding to the triangular patch; and
determining all of the intersection connection results and all of the target intersections both corresponding to all of the plurality of triangular patches as the third image processing result.

19. The non-transitory computer memory medium according to claim 16, wherein the performing, in accordance with the pixel grouping condition, a fourth image processing on non-triangular parts in the third image processing result, so as to obtain a fourth image processing result corresponding to the third image processing result comprises:
performing, in accordance with the pixel grouping condition, segmentation processing on the non-triangular parts in the third image processing result until it is determined that the third image processing result consists of the triangular patches, so as to obtain a segmentation processing result corresponding to the third image processing result;
classifying, for all of the triangular patches in the segmentation processing result, by taking the target section as a reference, each of the triangular patches that is located above the target section as a first patch and each of the triangular patches that is located below the target section as a second patch;
generating a plurality of first closed surfaces in accordance with all of the first patches, generating a plurality of second closed surfaces in accordance with all of the second patches, and identifying all of the plurality of first closed surfaces, and all of the plurality of second closed surfaces as target closed surfaces; and
performing, in accordance with a predetermined rendering mode, the gradient color rendering on each of the target closed surfaces, so as to obtain a gradient color rendering result corresponding to each of the target closed surfaces as a fourth image processing result.

20. The non-transitory computer memory medium according to claim 19, wherein the performing, in accordance with the predetermined rendering mode, the gradient color rendering on each of the target closed surfaces, so as to obtain the gradient color rendering result corresponding to each of the target closed surfaces comprises:
obtaining a two-dimensional surface projection corresponding to each of the target closed surfaces in the foundation plane, the two-dimensional surface projection comprising a first subsurface projection corresponding to each of the plurality of first closed surfaces, and a second subsurface projection corresponding to each of the plurality of second closed surfaces;
performing, in accordance with a predetermined first color system, the gradient color rendering for each of the first subsurface projections with a counterclockwise direction as a rendering direction, so as to obtain a first rendering result corresponding to each of the first subsurface projections;
performing, in accordance with a predetermined second color system, the gradient color rendering for each of the second subsurface projections with the counterclockwise direction as the rendering direction, so as to obtain a second rendering result corresponding to each of the second subsurface projections; and
identifying all of the first rendering results and all of the second rendering results as a gradient color rendering result.
